(19) United States
(12) Patent Application Publication
(10) Pub. No.: US 2009/0174849 A1
(43) Pub. Date: Jul. 9, 2009

(54) LIQUID CRYSTAL DISPLAY DEVICE, MANUFACTURING METHOD THEREOF, AND ELECTRONIC APPARATUS

(75) Inventors: Yasushi TAKANO, Matsumoto-shi (JP); Toshimitsu HIRAI, Hokuto-shi (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/346,282

(22) Filed: Dec. 30, 2008

(30) Foreign Application Priority Data
Jan. 8, 2008 (JP) 2008-001457

(51) Int. Cl. G02F 1/1335; G02F 1/13

(52) U.S. Cl. 349/106; 349/187

(57) ABSTRACT

A liquid crystal display device, includes: a liquid crystal layer; and a color developing section that has a multilayered interference film in which first transparent thin films and second transparent thin films are alternatively stacked in layers, and causes light passed through the liquid crystal layer to have predetermined color developing characteristics and to be emitted from the color developing section, each of the first transparent thin films being formed with a first formation material and having a first refractive index so that each of the first transparent thin films has a thickness determined based on the predetermined color developing characteristics, and each of the second transparent thin films being formed with a second formation material and having a second refractive index so that each of the second transparent thin films has a thickness determined based on the predetermined color developing characteristics.

### CROSS-REFERENCE TO RELATED APPLICATION

This application is based on and claims priority from Japanese Patent Application No. 2008-001457, filed on Jan. 8, 2008, the contents of which are incorporated herein by reference.

### BACKGROUND

1. Technical Field

The present invention relates to a liquid crystal display device, a manufacturing method thereof, and an electronic apparatus.

2. Related Art

Semi-transmission reflective types of liquid crystal display devices provided with a transmissive mode and a reflective mode have been known as a liquid crystal display device. As such a semi-transmission reflective type of liquid crystal display devices, there is proposed a liquid crystal display device in which a liquid crystal layer is held in between an upper substrate and a lower substrate, an inner surface of the lower substrate is provided with a reflection film having a light transmitting window formed on a metal film such as aluminum, and the reflection film functions as a semi-transmission plate.

In this case, in the reflective mode, outside light, which is incident into the upper substrate, passes through the liquid crystal layer and is reflected by the reflection film of the inner surface of the lower substrate. Then, the light passes through the liquid crystal layer again and is emitted from the upper substrate to contribute to a display operation. On the other hand, in the transmissive mode, light emitted from a backlight, which is incident into the lower substrate, passes through the liquid crystal layer from the window of the reflection film and is emitted to the outside from the upper substrate to contribute to a display operation.

Accordingly, in the area in which the reflection film is formed, an area in which the window is formed acts as a transmissive display area and the other area acts as a reflective display mode.

All the reflected light reflected by the reflection film and the transmitted light passing through the window of the reflection film is transmitted through a color filter layer so as to be colored by color developing characteristics, and contributes to a display operation.

Such a liquid crystal display device is disclosed in, for example, Japanese Unexamined Patent Application, First Publication No. 2003-330009.

However, the above-described prior art has the following problems.

A color filter layer provided for each pixel by using a predetermined colorant causes an increase in the number of processes and in the manufacturing cost.

In addition, since the color filter layer is provided, the thickness of the liquid crystal display device increases, and there is a problem in that a reduction of the thickness is not easily realized.

### SUMMARY

An advantage of some aspects of the invention is to provide a liquid crystal display device and a manufacturing method thereof, and an electronic apparatus, where it is possible to realize a reduction in manufacturing cost and a thinning of the liquid crystal display device and the electronic apparatus.

A first aspect of the invention provides a liquid crystal display device including: a first substrate; a second substrate opposed to the first substrate; a liquid crystal layer disposed between the first substrate and the second substrate; and a color developing section that has a multilayered interference film in which first transparent thin films and second transparent thin films are alternatively stacked in layers, and causes light passed through the liquid crystal layer to have predetermined color developing characteristics and to be emitted from the color developing section. Each of the first transparent thin films is formed with a first formation material and having a first refractive index so that each of the first transparent thin films has a thickness determined based on the predetermined color developing characteristics. Also, each of the second transparent thin films is formed with a second formation material and having a second refractive index so that each of the second transparent thin films has a thickness determined based on the predetermined color developing characteristics.

In the liquid crystal display device according to the first aspect of the invention, since color developing sections are formed in a simple manner such that a first formation material and a second formation material are each used to form a film so that the film has a thickness determined based on the color developing characteristics, it is not necessary to use a color filter. Accordingly, cost can be reduced and the liquid crystal display device can be made thin.

As characteristics of the color development, assuming that refractive indexes of a first formation material (first transparent thin film) and a second formation material (second transparent thin film) are n1 and n2, respectively, the thicknesses of the first transparent thin film and the second transparent thin film are t1 and t2, respectively, and refractive angles of the first transparent thin film and the second transparent thin film are θ1 and θ2; a reflective wavelength λ is represented by 2×(n1×t1×cos θ1+n2×t2×cos θ2) and a reflectance R (reflective intensity) is represented by (n1²−n2²)/(n1²+n2²).

When an optical thickness is n1×t1=n2×t2=λ/4, the color developing intensity is maximized.

Accordingly, in the liquid crystal display device according to the first aspect of the invention, when the refractive indexes n1 and n2 and the refractive angles θ1 and θ2 are preset according to the used materials, it is possible to produce light having a desired wavelength and a high color developing intensity by appropriately setting the thicknesses t1 and t2 of the first transparent thin film and the second transparent thin film on the basis of the formula.

It is preferable that, in the liquid crystal display device of the first aspect of the invention, the color developing section have a plurality of reference color developing sections, one of the reference color developing sections producing one reference color different from the other reference color of the reference color developing sections, and each of the reference color developing sections have the first transparent thin film and the second transparent thin film which are stacked in layers so that the thicknesses of the first transparent thin film and the second transparent thin film correspond to the reference color of each of the reference color developing sections.

In the liquid crystal display device according to the first aspect of the invention, since a plurality of reference color developing sections can be formed of the first transparent thin film and the second transparent thin film, materials to be used can be two kinds of materials, that is, the first formation material and the second formation material. Accordingly, it is possible to contribute to the reduction in manufacturing cost.

It is preferable that the liquid crystal display device of the first aspect of the invention further include: a division wall formed with a shading material. In the liquid crystal display device, the color developing section is surrounded by the division wall.

In the liquid crystal display device according to the first aspect of the invention, the area on which a liquid material including the first liquid material is to be applied can be accurately defined by the division wall; and negative effects on color developing characteristics, occurring by the incident light becoming stray light by being reflected by the division wall, can be suppressed.

It is preferable that, in the liquid crystal display device of the first aspect of the invention, the multilayered interference film include a first face, a second face which is opposite to the first face, and an irregularity formation section that forms an irregularity on the first face of the multilayered interference film.

In the liquid crystal display device according to the first aspect of the invention, the reflected light can be scattered by the first face of a multilayered interference film, and thus the light can be emitted as uniform light (coloring).

It is preferable that, in the liquid crystal display device of the first aspect of the invention, the irregularity formation section be a plurality of granular members dispersed and formed at a position which is close to the second face of the multilayered interference film.

In the liquid crystal display device according to the first aspect of the invention, by a simple step of distributing a plurality of granular members on a second face of the multilayered interference film, an irregularity can be easily formed on the first face of the multilayered interference film.

It is preferable that, in the liquid crystal display device of the first aspect of the invention, the irregularity formation section be formed of at least one of the first formation material and the second formation material.

In the liquid crystal display device according to the first aspect of the invention, a separate material for forming the irregularity is not provided. Accordingly, it is possible to contribute to the reduction in manufacturing cost.

It is preferable that, in the liquid crystal display device of the first aspect of the invention, the first refractive index be less than the second refractive index, and the first transparent thin film be formed so that the thickness of the first transparent thin film is greater than the thickness of the second transparent thin film.

In the liquid crystal display device according to the first aspect of the invention, it is possible to produce light having a desired wavelength with a high color developing intensity by appropriately selecting the film thicknesses t1 and t2 satisfying the relationship of the aforementioned formula n1×t1=n2×t2=λ/4.

It is preferable that, in the liquid crystal display device of the first aspect of the invention, the multilayered interference film that has a plurality of the first transparent thin films and a plurality of the second transparent thin films include a lowermost layer, an uppermost layer, and a plurality of intermediate layers. In the liquid crystal display device, the first transparent thin films and the second transparent thin films are formed so that the thicknesses of transparent thin films that are positioned at the lowermost layer and the uppermost layer are greater than the thickness of a transparent thin film that is positioned at one of the intermediate layers.

The liquid crystal display device of the first aspect of the invention is obtained based on the result of experiment and simulation. In the first aspect of the invention, it is possible to obtain satisfactory color developing characteristics.

In this case, it is particularly preferable that, in the liquid crystal display device of the first aspect of the invention, the first transparent thin films and the second transparent thin films be formed so that the thicknesses of the transparent thin films that are positioned at the lowermost layer and the uppermost layer are twice the thickness of the transparent thin film that is positioned at one of the intermediate layers. In this case, it is possible to obtain satisfactory light emitting characteristics (reflective characteristics).

It is preferable that, in the liquid crystal display device of the first aspect of the invention, the thickness of the first transparent thin film be determined based on a particle diameter of the first formation material.

In the liquid crystal display device of the first aspect of the invention, it is possible to precisely form the first transparent thin film with a regular thickness having uniformity.

It is preferable that, in the liquid crystal display device of the first aspect of the invention, the thickness of the second transparent thin film be determined based on a particle diameter of the second formation material.

In the liquid crystal display device of the first aspect of the invention, it is possible to precisely form the second transparent thin film with a regular thickness having uniformity.

A second aspect of the invention provides an electronic apparatus including the liquid crystal display device mentioned above.

The electronic device according to the second aspect of the invention can be made thin, and the manufacturing cost thereof can be reduced.

A third aspect of the invention provides a method for manufacturing a liquid crystal display device, including: preparing a first substrate and a second substrate opposed to the first substrate; disposing a liquid crystal layer between the first substrate and the second substrate; forming a first transparent thin film having a first refractive index with a first liquid material so that the first transparent thin film has a thickness determined based on predetermined color developing characteristics; forming a second transparent thin film having a second refractive index with a second liquid material so that the second transparent thin film has a thickness determined based on the predetermined color developing characteristics; stacking the first transparent thin films and the second transparent thin films in layers by alternately repeating the forming of the first transparent thin film and the forming of the second transparent thin film multiple times so that a multilayered interference film is formed; and obtaining a color developing section that causes light passed through the liquid crystal layer to have predetermined color developing characteristics and to be emitted from the color developing section.

In the method according to the third aspect of the invention, since color developing sections are formed in a simple manner such that a first liquid material and a second liquid material are each used to form a film so that the film has a thickness determined based on the color developing characteristics, it is not necessary to use a color filter. Accordingly, cost can be reduced and the thickness of the liquid crystal display device can be reduced.

As characteristics of the color development, assuming that refractive indexes of a first liquid material (first transparent thin film) and a second liquid material (second transparent thin film) are n1 and n2, respectively, the thicknesses of the first transparent thin film and the second transparent thin film are t1 and t2, respectively, and refractive angles of the first transparent thin film and the second transparent thin film are θ1 and θ2; a reflective wavelength λ is represented by 2×(n1×t1×cos θ1+n2×t2×cos θ2) and a reflectance R (reflective intensity) is represented by (n1²−n2²)/(n1²+n2²).

When an optical thickness is n1×t1=n2×t2=λ/4, the color developing intensity is maximized.

Accordingly, in the method according to the third aspect of the invention, when the refractive indexes n1 and n2 and the refractive angles θ1 and θ2 are preset according to the used materials, it is possible to produce light having a desired wavelength with a high color developing intensity by appropriately setting the thicknesses t1 and t2 of the first transparent thin film and the second transparent thin film on the basis of the formula.

It is preferable that, in the method of the third aspect of the invention, obtaining the color developing section include forming a plurality of reference color developing sections, and one of the reference color developing sections produce one reference color different from the other reference color of the reference color developing sections. In the method, the first transparent thin films and the second transparent thin films are stacked in layers in the forming of the reference color developing sections so that the thicknesses of the first transparent thin film and the second transparent thin film correspond to the reference color of each of the reference color developing sections.

In the method according to the third aspect of the invention, since a plurality of reference color developing sections can be formed of a first transparent thin film and a second transparent thin film, materials to be used can be two kinds of materials, that is, the first liquid material and the second liquid material. Accordingly, it is possible to contribute to the reduction in manufacturing cost.

It is preferable that the method of the third aspect of the invention further include: forming a division wall with a shading material so that the color developing section is surrounded by the division wall.

In the method according to the third aspect of the invention, the area on which a liquid material including the first liquid material is to be applied can be accurately defined by the division wall, and negative effects on color developing characteristics, occurring by the incident light becoming stray light by being reflected by the division wall, can be suppressed.

It is preferable that the method of the third aspect of the invention further include: forming an irregularity formation section that forms an irregularity on a first face of the multilayered interference film.

In the method according to the third aspect of the invention, the reflected light can be scattered by the first face of a multilayered interference film, and thus the light can be emitted as uniform light (coloring).

It is preferable that, in the method of the third aspect of the invention, the forming of the irregularity formation section include forming a plurality of granular members at a position which is close to a second face which is opposite to the first face of the multilayered interference film, in a way that the granular members are dispersed.

In the method according to the third aspect of the invention, by a simple step of distributing a plurality of granular members on a second face of the multilayered interference film, an irregularity can easily be formed on the first face of the multilayered interference film.

It is preferable that, in the method of the third aspect of the invention, the granular members be formed from at least one of the first liquid material and the second liquid material.

In the method according to the third aspect of the invention, providing a separate material for forming the irregularity is not required. Accordingly, it is possible to contribute to the reduction in manufacturing cost.

It is preferable that, in the method of the third aspect of the invention, at least one of the first transparent thin film and the second transparent thin film be formed by a liquid droplet ejection method.

In the method of the third aspect of the invention, it is possible to efficiently apply the minimal amount of a liquid material only onto desired regions, thereby improving productivity.

It is preferable that, in the method of the third aspect of the invention, each of the forming of the first transparent thin film and the forming of the second transparent thin film include: applying a liquid material and baking or drying the liquid material that has been applied.

In the method of the third aspect of the invention, the first liquid material and the second liquid material are formed into films in the forming of the first transparent thin film and the forming of the second transparent thin film. Accordingly, it is possible to prevent the applied first liquid material and the applied second liquid material from mixing to have a negative effect on the color developing characteristics.

It is preferable that, in the method of the third aspect of the invention, the first refractive index be less than the second refractive index, and the first transparent thin film be formed so that the thickness of the first transparent thin film is greater than the thickness of the second transparent thin film.

In the method according to the third aspect of the invention, it is possible to produce light having a desired wavelength and a high color developing intensity by appropriately selecting the film thicknesses t1 and t2 satisfying the relationship of the aforementioned formula n1×t1=n2×t2=λ/4.

It is preferable that, in the method of the third aspect of the invention, the multilayered interference film that has a plurality of the first transparent thin films and a plurality of the second transparent thin films include a lowermost layer, an uppermost layer, and a plurality of intermediate layers. In the method, the first transparent thin films and the second transparent thin films are formed so that the thicknesses of transparent thin films that are positioned at the lowermost layer and the uppermost layer are greater than the thickness of a transparent thin film that is positioned at one of the intermediate layers.

It is preferable that, in the method of the third aspect of the invention, the color developing structure that is constituted by a plurality of the first transparent thin films and a plurality of the second transparent thin films include a lowermost layer, an uppermost layer, and a plurality of intermediate layers. In this method, the first transparent thin films and the second transparent thin films are formed so that the thicknesses of the transparent thin films that are positioned at the lowermost layer and the uppermost layer are greater than the thickness of the transparent thin film that is positioned at one of the intermediate layers.

This method of the third aspect of the invention is obtained based on the result of experiment and simulation. In the third aspect of the invention, it is possible to obtain satisfactory color developing characteristics.

In this case, it is particularly preferable that, in the method of the third aspect of the invention, the first transparent thin films and the second transparent thin films be formed so that the thicknesses of the transparent thin films that are positioned at the lowermost layer and the uppermost layer are twice the thickness of the transparent thin film that is positioned at one of the intermediate layers. In this case, it is possible to obtain satisfactory light emitting characteristics (reflective characteristics).

It is preferable that, in the method of the third aspect of the invention, the forming of the first transparent thin film and the second transparent thin film include at least one of the forming the first transparent thin film that has the thickness determined based on a particle diameter of a first formation material used for forming the first transparent thin film, and the forming the second transparent thin film that has the thickness determined based on a particle diameter of a second formation material used for forming the second transparent thin film.

In the third aspect of the invention, it is possible to precisely form at least one of the first transparent thin film and the second transparent thin film with a regular thickness having uniformity.

### BRIEF DESCRIPTION OF THE DRAWINGS

FIG. 1 is a perspective view showing a liquid drop ejection apparatus.

FIG. 2A is a perspective view showing a liquid drop ejection head, and FIG. 2B is a cross-sectional view showing the liquid drop ejection head.

FIG. 3 is a cross-sectional view showing a liquid crystal display device according to a first embodiment of the invention.

FIG. 4 is a cross-sectional view showing a reference color developing section having a multilayer structure formed on a substrate.

FIGS. 5A to 5C are diagrams illustrating the relationship between light emitting wavelength and reflectance according to the first embodiment of the invention.

FIG. 6 is a cross-sectional view showing a reference color developing section according to a second embodiment of the invention.

FIG. 7A is a diagram illustrating the refractive index and the thickness of each of eleven layers of a reference color developing section according to a third embodiment, and FIG. 7B is a diagram illustrating the relationship between wavelength and reflectance in the film structure shown in FIG. 7A.

FIG. 8A is a diagram illustrating the refractive index and the thickness of each of eleven layers of a reference color developing section according to the third embodiment, and FIG. 8B is a diagram illustrating the relationship between wavelength and reflectance in the film structure shown in FIG. 8A.

FIG. 9A is a diagram illustrating the refractive index and the thickness of each of eleven layers of a reference color developing section according to the third embodiment, and FIG. 9B is a diagram illustrating the relationship between wavelength and reflectance in the film structure shown in FIG. 9A.

FIG. 10A is a diagram illustrating the refractive index and the thickness of each of eleven layers of a reference color developing section according to the third embodiment, and FIG. 10B is a diagram illustrating the relationship between wavelength and reflectance in the film structure shown in FIG. 10A.

FIG. 11A is a diagram illustrating the refractive index and the thickness of each of eleven layers of a reference color developing section according to the third embodiment, and FIG. 11B is a diagram illustrating the relationship between wavelength and reflectance in the film structure shown in FIG. 11A.

FIG. 12A is a diagram illustrating the refractive index and the thickness of each of eleven layers of a reference color developing section according to the third embodiment, and FIG. 12B is a diagram illustrating the relationship between wavelength and reflectance in the film structure shown in FIG. 12A.

FIG. 13A is a diagram illustrating the refractive index and the thickness of each of eleven layers of a reference color developing section according to the third embodiment, and FIG. 13B is a diagram illustrating the relationship between wavelength and reflectance in the film structure shown in FIG. 13A.

FIG. 14A is a diagram illustrating the refractive index and the thickness of each of eleven layers of a reference color developing section according to the third embodiment, and FIG. 14B is a diagram illustrating the relationship between wavelength and reflectance in the film structure shown in FIG. 14A.

FIG. 15A is a diagram illustrating the refractive index and the thickness of each of eleven layers of a reference color developing section according to a fourth embodiment, and FIG. 15B is a diagram illustrating the relationship between wavelength and reflectance in the film structure shown in FIG. 15A.

FIGS. 16A to 16C are perspective views showing an electronic apparatus having the liquid crystal display device of the invention.

### DESCRIPTION OF EXEMPLARY EMBODIMENTS

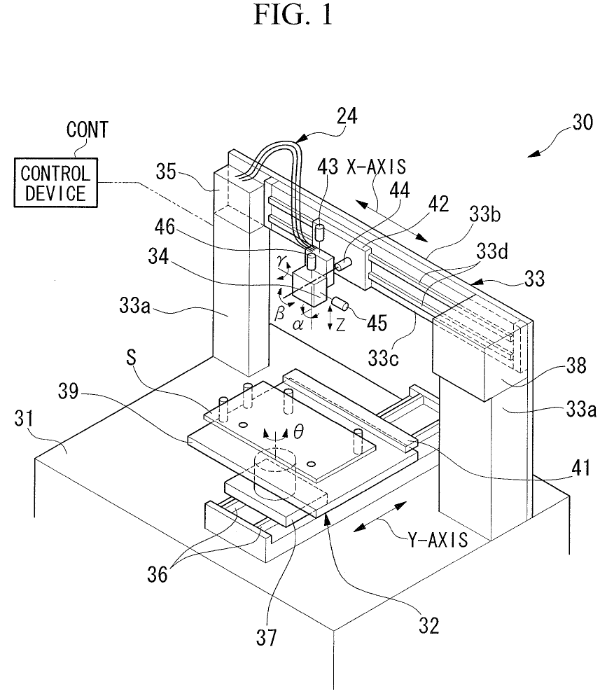

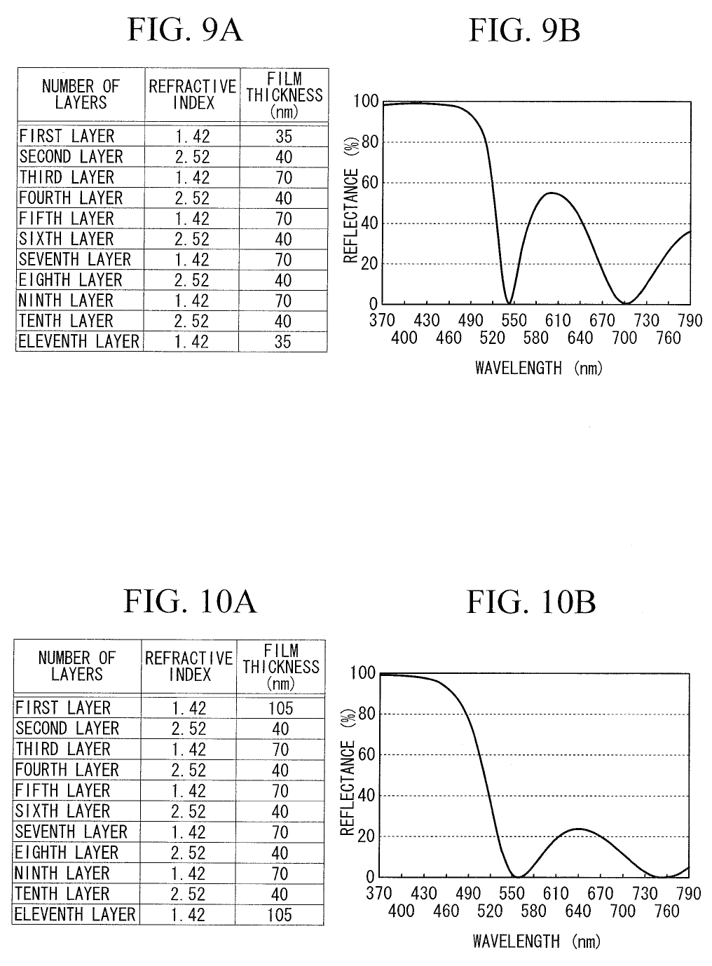

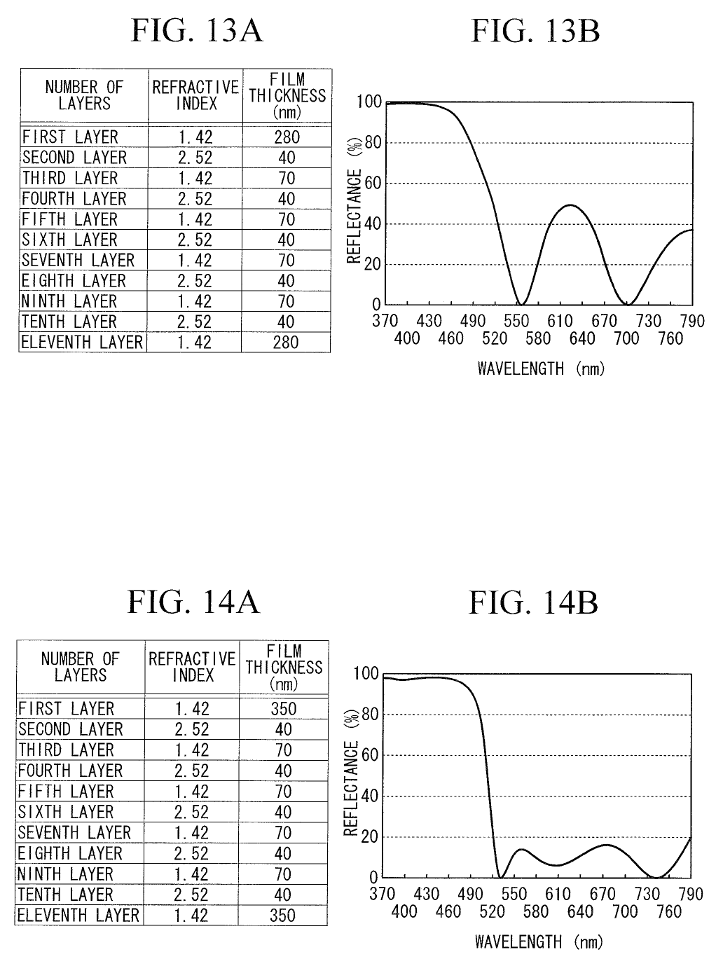

Hereinafter, embodiments of a liquid crystal display device and a manufacturing method thereof will be described with reference to FIGS. 1 to 16C.

In these drawings which are utilized in the following explanation, appropriate changes have been made in the scale of the various members, in order to represent them at scales at which they can be easily understood.

Liquid Drop Ejection Apparatus

Firstly, a liquid drop ejection apparatus for use in the manufacture of a method for manufacturing a liquid crystal display device will be described.

FIG. 1 shows a liquid drop ejection apparatus. The liquid drop ejection apparatus 30 is provided with a base 31, a substrate handling section 32, a head moving section 33, a liquid drop ejection head 34, a liquid storage tank 35, a controller CONT (controlling section), and the like.

The substrate handling section 32 and the head moving section 33 are provided on the base 31.

The substrate handling section 32 is provided on the base 31. The substrate handling section 32 is provided with a guide rail 36 which is disposed in a Y-axis direction. The substrate handling section 32 is configured to cause a slider 37 to move along the guide rail 36 by, for example, a linear motor.

The slider 37 has a motor for the θ axis (not shown). This motor is, for example, a direct drive motor, and the rotor (not shown) is fixed to a table 39. In this constitution, when electrical power is provided to the motor, the rotor and the table 39 rotate along the θ direction, and a rotation angle of the table 39 is indexed (rotation index).

The table 39 sets a substrate P to a predetermined position and holds the substrate P. That is, the table 39 has a known suction and holding device (not shown), and causes the suction and holding device to be driven so as to suction and hold the substrate P on the table 39.

The substrate P is located on the table 39 at a predetermined location with a high level of precision by a position-determination pin. The substrate P is thereby held on the table 39.

On the table 39, a dust shot area (not shown) is provided for a dust shot or a trial shot of an ink from the liquid drop ejection head 34. In this embodiment, this dust shot area is formed so as to extend along the X-axis direction, and is provided on the back section of the table 39.

The head moving section 33 has a pair of pedestals 33a and 33a which are standing on the back section of the base 31, and a traveling rail 33b which is provided on upper portions of these pedestals 33a and 33a. The head moving section 33 is placed along the X-axis direction, that is, along a direction orthogonal to the Y-axis direction of the substrate handling section 32.

The traveling rail 33b includes a holding plate 33c and a pair of guide rails 33d and 33d. The holding plate 33c is built between the pedestals 33a and 33a. The pair of guide rails 33d and 33d is provided on the holding plate 33c. Furthermore, the traveling rail 33b holds a slider 42 holding the liquid drop ejection head 34 so that the slider 42 can move along the extending direction of the guide rails 33d and 33d. The slider 42 runs on the guide rails 33d and 33d by drive of a linear motor (not shown). Therefore, the slider 42 is configured to cause the liquid drop ejection head 34 to move along the X-axis direction.

Motors 43, 44, 45, and 46, as oscillation position determination sections, are connected to the liquid drop ejection head 34. When the motor 43 is activated, the liquid drop ejection head 34 moves upward and downward along the Z-axis, and thus a position determination can be performed on the Z-axis. Moreover, the Z-axis is a direction (up and down direction) orthogonal to the X-axis and the Y-axis. In addition, when the motor 44 is activated, the liquid drop ejection head 34 oscillates along the β direction in FIG. 1, and thus a position determination can be performed. When the motor 45 is activated, the liquid drop ejection head 34 oscillates along the γ direction, and thus a position determination can be performed. When the motor 46 is activated, the liquid drop ejection head 34 oscillates along the a direction, and thus a position determination can be performed.

On the slider 42, the liquid drop ejection head 34 can be fixed to a predetermined position by moving directly along the Z-axis direction, and also can be fixed to a predetermined position by traveling along the α, β, and γ directions. Therefore, a direction orthogonal to an ink ejecting face and a position or an attitude of the liquid drop ejection head 34 against the substrate S disposed on the table 39 can be controlled with a high level of precision.

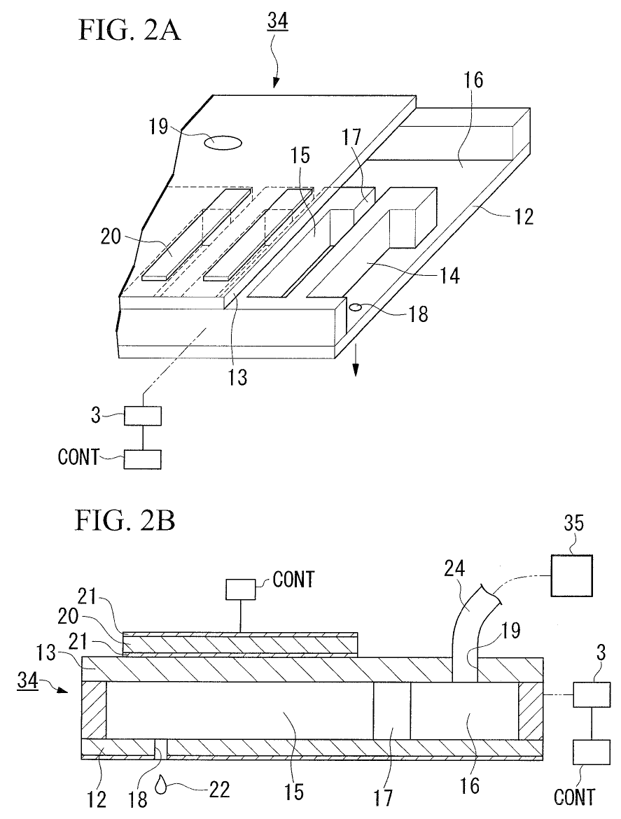

FIG. 2A is a perspective view showing the liquid drop ejection head 34, and FIG. 2B is a cross-sectional view showing the liquid drop ejection head 34.

As shown in FIG. 2A, the liquid drop ejection head 34 has a nozzle plate 12 and a vibration plate 13 which, for example, are made of stainless steel material, and combining them while interposing an separation member 14 (reservoir plate) therebetween. Between the nozzle plate 12 and the vibration plate 13, a plurality of cavities 15 and reservoirs 16 are formed by the separation members 14, and these cavities 15 and reservoirs 16 are connected through paths 17.

In addition, the liquid drop ejection head 34 is provided with a heater 3 (heating section). Electrical energy that is supplied to the heater 3 is controlled by the controller CONT.

The interiors of each cavity 15 and the reservoir 16 can be filled with a liquid material, and the path 17 therebetween functions as a supply path which supplies the liquid material from the reservoir 16 to the cavity 15. In addition, a plurality of hole-shaped nozzles 18 for ejecting a liquid material from the cavity 15 is formed in a state in which they are aligned vertically and horizontally. On the other hand, at the vibration plate 13, a hole 19 which is open to the inside of the reservoir 16 is formed, and a liquid material tank 35 is connected to the hole 19 via a tube 24 (refer to FIG. 1).

In addition, as shown in FIG. 2B, a piezoelectric element 20 is connected to the face of vibration plate 13 which is opposite to the face facing the vibration plate 15. The piezoelectric element 20 is sandwiched between a pair of electrodes 21 and 21, and is configured to flexibly bend and protrude to outside of the liquid drop ejection head 34 by an electrical power supply. The piezoelectric element 20 functions as an ejection section of the invention.

In this constitution, the vibration plate 13 which is connected to the piezoelectric element 20 is integrated with the piezoelectric element 20 as one unit. The vibration plate 13 flexibly bends toward the outside of the liquid drop ejection head 34 so as to coincide with the bending of the piezoelectric element 20. By this bending, the capacity inside the cavity 15 increases. In the case in which the interior of the reservoir 16 is filled with a liquid material, since the interiors of the cavity 15 and reservoir 16 are open to each other, the liquid material whose volume is equal to the increased volume in the cavity 15 flows into the cavity 15 from the reservoir 16 via the path 17. Simultaneously, the liquid material whose volume is equal to the volume of the liquid material that has been flowed into the cavity 15 is supplied to the reservoir 16 via the tube 24.

If power supplied to the piezoelectric element 20 is stopped so as to turn off electricity from the above-described state, the shapes of the piezoelectric element 20 and the vibration plate 13 return to their original shape. Therefore, because the volume in the cavity 15 returns to the original volume, the pressure of the liquid material inside the cavity 15 increases, and then a liquid droplet 22 of the liquid material is ejected from the nozzle 18.

In this embodiment, a plurality of kinds of liquid material is stored in the liquid storage tank 35. Practically, two kinds of liquid material are used as described below. Each of the kinds of liquid material is supplied to each reservoir 16 that corresponds to each liquid material via the tube 24 that corresponds to each liquid material. Furthermore, each of the kinds of liquid material is ejected as liquid droplets from the nozzle 18 that correspond to each liquid material.

In addition, the controller CONT controls the piezoelectric elements 20 so that the piezoelectric elements 20 are selectively driven and a predetermined kind of liquid material is ejected.

Moreover, as an ejection method of the liquid drop ejection head, the methods except for an electromechanical conversion method which uses the above-described piezoelectric element 20 can be adopted. For example, a method in which the electro-thermal conversion member as an energy producing element is used, a continuous method such as a electrification control method, and a pressurization vibration method, a static aspiration method, and a method in which a liquid material is ejected by heating caused by irradiating electromagnetic waves such as a laser, can be adopted.

Returning to FIG. 1, another configuration of the liquid drop ejection apparatus 30 will be described.

The controller CONT controls the operation of the ejection of the liquid material of the above-described liquid drop ejection head 34, the operation of the driving of the substrate handling section 32 and the head moving section 33, supplying electrical energy to the heater 3, or the like.

The above-described liquid material tank 35 is disposed at the upper portion of one of the pedestals 33a. A heater (not shown) is equipped inside or outside of the liquid material tank 35. The heater heats the liquid material stored in the liquid material tank 35. Particularly, for example, in the case in which the liquid material has a high degree of viscosity, the heater causes the degree of viscosity of the liquid material to be reduced by heating. Therefore, the heater causes the liquid material to be able to easily flow into the liquid drop ejection head 34 from the liquid material tank 35.

Since the pedestals 33a supports the traveling rail 33b, the liquid material tank 35 is disposed at a position which is sufficiently close to the liquid drop ejection head 34 traveling on the traveling rail 33b.

Therefore, the length of the tube 24 that causes the liquid material to flow into the liquid drop ejection head 34 from the liquid material tank 35 is sufficiently shorter than a conventional tube, that is, the length of the tube 24 is substantially the same length as the traveling rail 33b.

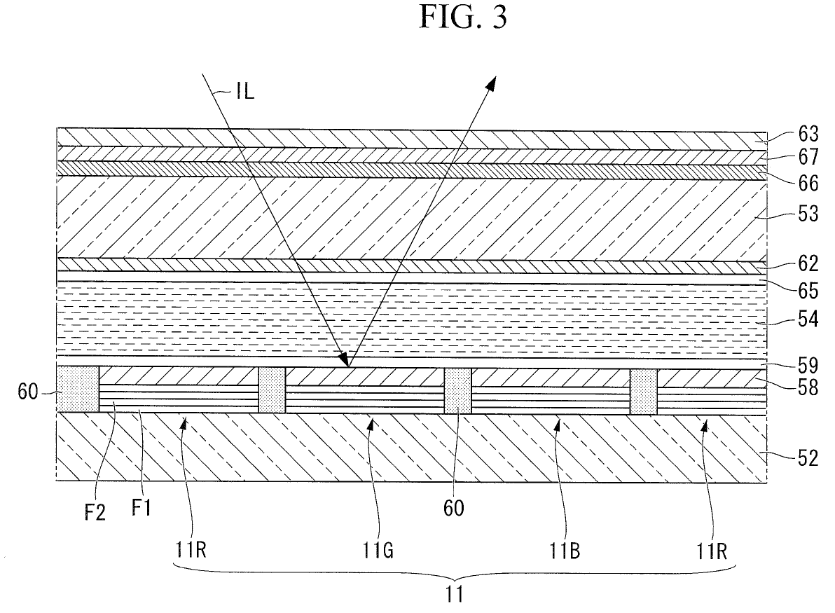

Next, a liquid crystal display device manufactured by the above-described liquid drop ejection apparatus will be described with reference to FIG. 3.

As shown in FIG. 3, the liquid crystal display device of this embodiment includes a lower substrate 52 (first substrate) and an upper substrate 53 (second substrate) that are disposed so as to face each other, a liquid crystal layer 54 that is sandwiched between the lower substrate 52 and the upper substrate 53 and constituted by a STN (Super Twisted Nematic) liquid crystal, or the like.

The lower substrate 52 is formed of a glass, resin, or the like. A color developing section 11 constituted by a multilayered interference film is formed on an inside face of the lower substrate 52.

The color developing section 11 includes reference color developing sections 11R, 11G, and 11B. In the reference color developing sections 11R, 11G, and 11B, one of the reference color developing sections produces one reference color different from the other reference color of the reference color developing section. That is, the reference color developing sections 11R, 11G, and 11B produce a red color (R), a green color (G), and a blue color (B), respectively.

In addition, details regarding to the reference color developing sections 11R, 11G, and 11B will be described below.

The color developing section 11 (reference color developing sections 11R, 11G, and 11B) is surrounded by a division wall 60.

The division wall 60 is formed of, for example, a black-colored photosensitive resin film. As the black-colored photosensitive resin film, for example, a material including at least a positive type or negative type photosensitive resin that is generally used as a photo-resist, a black-colored inorganic pigment or organic pigment such as a carbon black, or a shading material may be used.

The division wall 60 includes a black-colored inorganic pigment or organic pigment. Since the division wall 60 is formed on a portion except for the portion on which the color developing section 11 (reference color developing sections 11R, 11G, and 11B) is formed, the light produced from the color developing section is prevented from being transmitted through the division walls 60. Therefore, the division wall 60 functions as a shading film.

A pixel electrode 58 formed of a transparent conductive film such as ITO (Indium Tin Oxide) is formed on each of the reference color developing sections 11R, 11G, and 11B.

An oriented film 59 formed of a material such as a polyimide is formed so as to cover the color developing section 11 (reference color developing sections 11R, 11G, and 11B), the division wall 60, and the pixel electrode 58 so as to be stacked in layers.

On the other hand, the upper substrate 53 is formed of a glass, a resin, or the like. A common electrode 62 formed of a transparent conductive film such as ITO is formed on an inside face of the upper substrate 53. An oriented film 65 formed of a material such as a polyimide is formed so as to cover the common electrode 62. Therefore, the common electrode 62 and the oriented film 65 are stacked on the inside face of the upper substrate 53 in layers.

Furthermore, a forward-dispersion plate 66, a retardation plate 67, and an upper polarization plate 63 are staked in order on an outside face of the upper substrate 53 in layers.

### First Embodiment

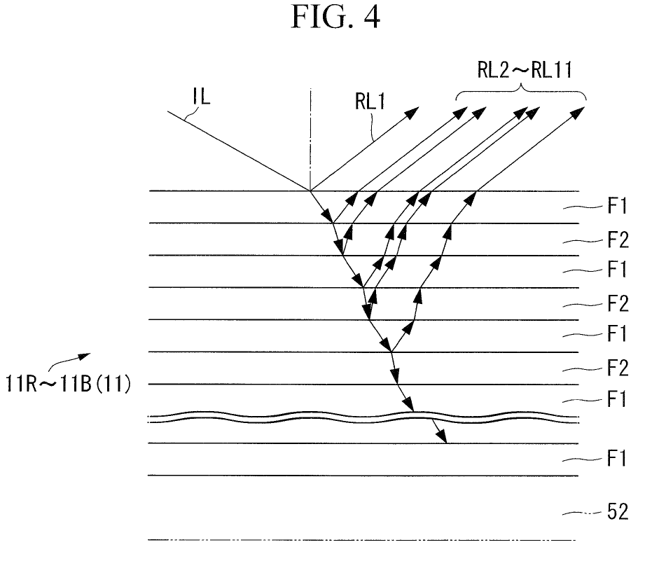

Next, a first embodiment of the reference color developing sections and a manufacturing method thereof will be described with reference to FIG. 4.

As shown in FIG. 4, each of the reference color developing sections 11R, 11G, and 11B is formed by alternately forming a plurality of first transparent thin films F1 and a plurality of second transparent thin films F2 having different refractive indexes.

In the first embodiment, in order from the lower substrate 52, the first transparent thin films F1 are formed in odd-numbered layers such as a first layer, a third layer, . . . , to an eleventh layer. Also, the second transparent thin films F2 are formed in even-numbered layers such as a second layer, . . . , to a tenth layer. Therefore, each of the reference color developing sections 11R, 11G, and 11B is formed by the eleven-layer thin films.

As a material for forming the first transparent thin film F1 and the second transparent thin film F2, polysiloxane resin (refractive index 1.42), SiO₂ (quartz; 1.45), Al₂O₃ (alumina; refractive index 1.76), ZnO (zinc oxide; refractive index 1.95), titanium oxide (refractive index 2.52), Fe₂O₃ (iron oxide; refractive index 3.01), or the like may be appropriately selected.

To form each of the reference color developing sections 11R, 11G, and 11B on the lower substrate 52 (substrate P), firstly, a division wall 60 is formed by a method such as a liquid droplet ejection method using the liquid drop ejection apparatus 30. Recess regions that are surrounded by the division wall 60 are thereby formed. Next, liquid droplets of a first liquid material including a material (first formation material) for forming the first transparent thin film are applied onto the recess region of the lower substrate 52 with a predetermined thickness by using the liquid drop ejection apparatus 30. Next, the first liquid material is dried, for example, at 180° C. for 1 minute and baked (cured) at 200° C. for 3 minutes. As a result, the first transparent thin film F1 is formed on the recess region of the lower substrate 52. That is, the first transparent thin film F1 is formed as the first layer of a film body that will be the reference color developing section (first process). Therefore, the first transparent thin film F1 is formed in each of the recess regions on which the reference color developing sections 11R, 11G, and 11B are formed, respectively.

Next, liquid droplets of a second liquid material including a material (second formation material) for forming the second transparent thin film are applied onto the first transparent thin film F1 with a predetermined thickness by using the liquid drop ejection apparatus 30, and then it is dried and baked under the same conditions. As a result, the second transparent thin film F2 is formed as the second layer of a film body that will be the reference color developing section (second process). Therefore, the second transparent thin film F2 is formed in each of the recess regions on which the reference color developing sections 11R, 11G, and 11B are formed, respectively. In other words, this second transparent thin film F2 that is formed on the first transparent thin film F1 is formed as a first layer of the second transparent thin film F2 in a plurality of layers of the film body that will be the reference color developing section.

The first process and the second process, as described above, are alternately repeated, that is the first process is performed six times and the second process is performed five times, thereby forming each of the reference color developing sections 11R, 11G, and 11B in which the first transparent thin film F1 and the second transparent thin film F2 are formed with a predetermined thickness.

In the first embodiment, each of the reference color developing sections 11R, 11G, and 11B is formed using the thin film materials, in which the refractive index (first refractive index) of the first transparent thin film F1 is less than the refractive index (second refractive index) of the second transparent thin film F2, and the thickness of the first transparent thin film F1 is greater than the thickness of the second transparent thin film F2.

As a color developing characteristics (first color developing characteristics) of each of the reference color developing sections 11R, 11G, and 11B having the multilayer structure, reflected light RL1 reflected by the uppermost layer transparent thin film with respect to incident light IL interferes with reflected light RL2 to RL11 that refracts and enters the transparent thin film and is reflected by the next layer transparent thin film and the layer transparent thin films below it, and passes out.

With regard to an interference color (reflective wavelength) and an intensity, on the basis of a thin film interference theory, when refractive indexes of the first transparent thin film F1 and the second transparent thin film F2 are n1 and n2, respectively, the thicknesses of the first transparent thin film F1 and the second transparent thin film F2 are t1 and t2, respectively, and refractive angles of the first transparent thin film F1 and the second transparent thin film F2 are θ1 and θ2; a reflective wavelength λ is represented by the following formula.

λ=2×(n1×t1×cos θ1+n2×t2×cos θ2) (1)

A reflectance (reflective intensity) R is represented by the following formula.

R=(n1²−n2²)/(n1²+n2²) (2)

As clearly seen from the formula (1) representing the reflectance, the difference between the refractive indexes of the first transparent thin film F1 and the second transparent thin film F2 is large. Accordingly, as the reflective intensity (color developing intensity) increases, the difference between the refractive indexes of the first transparent thin film F1 and the second transparent thin film F2 becomes larger.

When the following formula is satisfied, the color developing intensity becomes maximized.

n1×t1=n2×t2=λ/4 (3)

When the materials of the first transparent thin film F1 and the second transparent thin film F2 are selected, for example, on the basis of the reflective intensity; the refractive indexes n1 and n2 and the refractive angles θ1 and θ2 are determined. Accordingly, using the formulas (1) to (3), it is possible to set the number of layers to obtain: desired color developing characteristics (λ), the thickness t1 of the first transparent thin film F1 and the thickness t2 of the second transparent thin film F2, and a desired reflectance.

### EXAMPLE

A first transparent thin film F1 and a second transparent thin film F2 were formed using a first liquid material including a siloxane polymer (refractive index 1.42) as the first transparent thin film F1 and using a second liquid material including a titanium oxide (refractive index 2.52) as the second transparent thin film F2.

For example, to produce a blue color (λ=480 nm), the first transparent thin film F1 was formed with a thickness t1 of 84.5 nm and the second transparent thin film F2 was formed with a thickness t2 of 47.6 nm, on the basis of the formula (3).

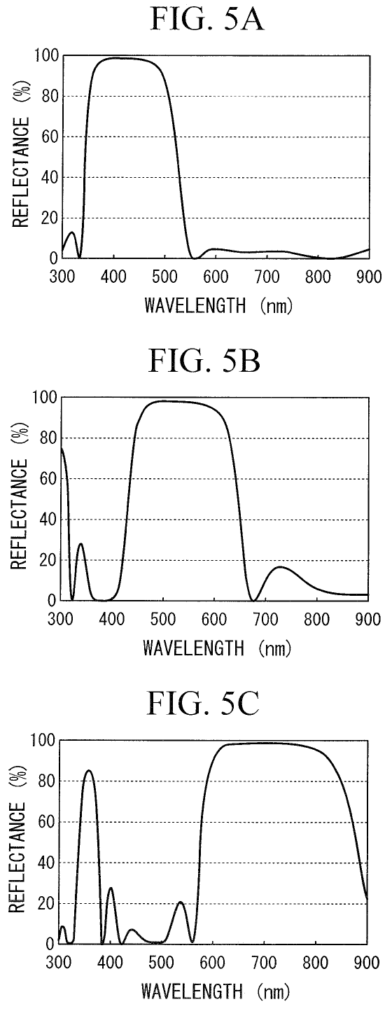

As a result, as shown in FIG. 5A, it is possible to obtain blue color developing characteristics at a reflectance that is greater than or equal to 80%.

Similarly, for example, to produce a green color (λ=520 nm), the first transparent thin film F1 was formed with a thickness t1 of 91.5 nm and the second transparent thin film F2 was formed with a thickness t2 of 52.0 nm, on the basis of the formula (3).

As a result, as shown in FIG. 5B, it is possible to obtain green color developing characteristics at a reflectance that is greater than or equal to 80%.

Similarly, for example, to produce a red color (λ=630 nm), the first transparent thin film F1 was formed with a thickness t1 of 111.0 nm and the second transparent thin film F2 was formed with a thickness t2 of 62.5 nm, on the basis of the formula (3).

As a result, as shown in FIG. 5C, it is possible to obtain red color developing characteristics at a reflectance that is greater than or equal to 80%.

In the above-described liquid crystal display device, light IL incident through the upper polarization plate 63, the retardation plate 67, the forward-dispersion plate 66 and the liquid crystal layer 54 reaches the reference color developing sections 11R, 11G, and 11B and is then reflected. Therefore, the light is emitted with the color developing characteristics based on the on/off of the liquid crystal layer 54 being on or off, and the reference color developing sections 11R, 11G, and 11B.

In this manner, in the first embodiment, a liquid droplet ejection method is used to alternately form and stack the first transparent thin film F1 and the second transparent thin film F2 so that the transparent thin films F1 and F2 have the thickness determined based on the desired color developing characteristics. Thus, the reference color developing sections 11R, 11G, and 11B having the desired color developing characteristics can be easily and efficiently manufactured without an increase in the number of processes or the use of large-sized equipment. Accordingly, in the first embodiment, it is not required to use a color filter causing an increase in the number of processes, in the manufacturing cost, and in the thickness of the liquid crystal display device. Therefore, the liquid crystal display device in which the reduction in cost and thinning of the thickness thereof is realized can be easily provided.

Furthermore, in the first embodiment, since division walls 60 surrounding each of the reference color developing sections 11R, 11G, and 11B have a light-shielding property, the reference color developing sections 11R, 11G, and 11B can be easily formed using the liquid droplet ejection method and the incident light IL can be prevented from being transmitted through the division walls 60. In addition, the incident light can also be prevented from being reflected to become stray light. Thus, negative effects on color developing characteristics can be suppressed.

In the first embodiment, it is possible to produce different color developing characteristics by the simple structure that is formed by two kinds of liquid materials so that the thicknesses of the transparent thin films F1 and F2 are optionally determined in each reference color developing section. In addition, it is possible to contribute to an improvement in productivity by the simplification in number of processes and a reduction in the number of types of materials.

In the first embodiment, the transparent thin film layers are applied and dried (baked) and then a next transparent thin film layer is formed. Accordingly, negative effects on color developing characteristics, occurring by the mixing of the applied first liquid material and second liquid material, can be prevented and the thicknesses of the layers can be accurately managed.

### Second Embodiment

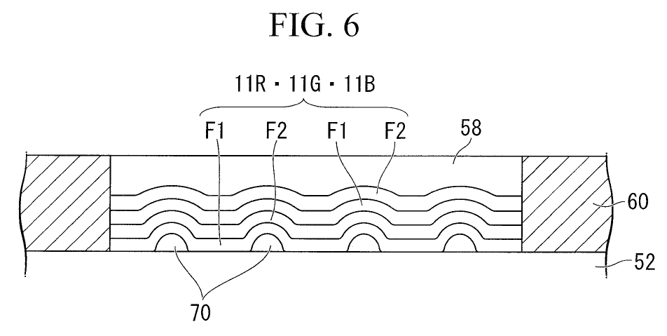

Next, a second embodiment of the reference color developing sections and a manufacturing method thereof will be described with reference to FIG. 6. Therefore, in FIG. 6, identical symbols are used for the elements which are identical to those of the above-described embodiment shown in FIGS. 1 to 5C, and the explanations thereof are omitted or simplified.

As shown in FIG. 6, in the reference color developing sections 11R, 11G, and 11B according to the second embodiment, a plurality of granular members 70 functions as an irregularity formation section that forms an irregularity on a front face (first face) of a multilayered interference film in which the first transparent thin films F1 and the second transparent thin films F2 are stacked in layers (herein, only the two layers are shown in FIG. 6 for the convenience), are distributed with intervals at a portion which is close to a back face (second face) of the multilayered interference film.

The granular members 70 are not particularly limited in material. However, in the second embodiment, the first liquid material (first formation material) is used as the material of the granular members 70. That is, in the second embodiment, in the reference color developing sections 11R, 11G, and 11B, the liquid drop ejection apparatus 30 is used before the formation of the first and second transparent thin films F1 and F2 to place (apply) the first liquid material in a dot shape on the lower substrate 52 and dry (or bake) it.

Then, by alternately stacking the first transparent thin films F1 and the second transparent thin films F2 in layers in the same sequence as described above, the reference color developing sections 11R, 11G, and 11B of which the front face has an irregularity in accordance with the positions of the granular members 70 can be obtained.

In the reference color developing sections 11R, 11G, and 11B having the above-described structure, since incident light can be dispersed by the irregularity on the front face, the light can be emitted as uniform light (coloring). Furthermore, in the second embodiment, since the granular members 70 are formed by the first liquid material, another material does not need to be provided. Accordingly, it contributes to an improvement in manufacturing efficiency. The granular members 70 can be formed using the second liquid material. However, in view of manufacturing efficiency, it is preferable that the granular members be formed using the same material as that of the first transparent thin film F1 to be subsequently formed.

### Third Embodiment

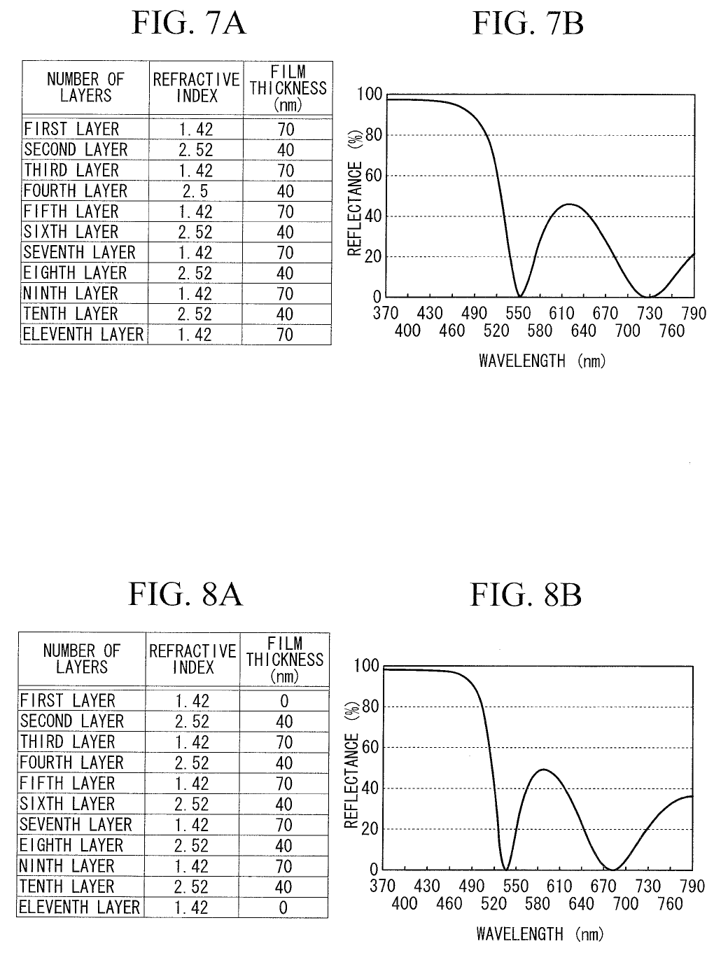

Next, a third embodiment of the reference color developing sections 11R, 11G, and 11B will be described with reference to FIGS. 7A to 14B.

In the above-described embodiments, the first transparent thin film F1 and the second transparent thin film F2 are formed with the same thickness.

However, in the third embodiment, in the above-described film body including the uppermost layer, the lowermost layer, and a plurality of intermediate layers, each of the thicknesses of the uppermost layer and the lowermost layer is different from the thickness of one of the intermediate layers.

As described above, FIG. 7A shows the first transparent thin film F1 formed by the siloxane polymer (refractive index 1.42) in the odd layers, and the second transparent thin film F2 formed by the titanium oxide (refractive index 2.52) in the even layers. In this case, in order to obtain a blue reflective spectrum of a wavelength of 430 to 450 nm, the thickness of the first transparent thin film F1 is 70 nm, and the thickness of the second transparent thin film F2 is 40 nm.

FIG. 7B is a diagram illustrating light emitting characteristics, specifically illustrating the relationship between a light emitting wavelength and a reflectance in the reference color developing section 11B that is formed of the first transparent thin films F1 and the second transparent thin films F2 and has the eleven layers shown in FIG. 7A.

FIGS. 8A to 14A are diagrams illustrating that the thicknesses of the first layer that is the lowermost layer, and the eleventh layer that is the uppermost layer, are changed 0 times (i.e., thickness is zero), 0.5 times, 1.5 times, 2 times, 3 times, 4 times, and 5 times the thickness of one of the intermediate layers. This thickness of one of the intermediate layers is the greatest thickness (70 nm) in the first transparent thin film F1 and the second transparent thin film F2 that constitute the intermediate layers (second to tenth layers) shown in FIG. 7A.

FIGS. 7B to 14B are diagrams illustrating light emitting characteristics, specifically illustrating the relationship between a light emitting wavelength and a reflectance in the reference color developing section 11B that is formed of the first transparent thin films F1 and the second transparent thin films F2 and has the eleven layers shown in FIGS. 7A to 14A.

As shown in the light emitting characteristics of FIGS. 7B, 8B, and 9B, when the thicknesses of the uppermost layer and the lowermost layer are less than the thickness of the layer that constitutes one of the intermediate layers and has the greatest thickness in the intermediate layers, the reflective peak becomes large in a wavelength region except for in a predetermined region.

As shown in the light emitting characteristics of FIGS. 10B, 11B, and 14B, when the thicknesses of the uppermost layer and the lowermost layer are 1.5 times, 2 times, and 5 times the thickness of the layer that constitutes one of the intermediate layers and has the greatest thickness in the intermediate layers, it is possible to decrease the reflective peak in a wavelength region except for in a predetermined region.

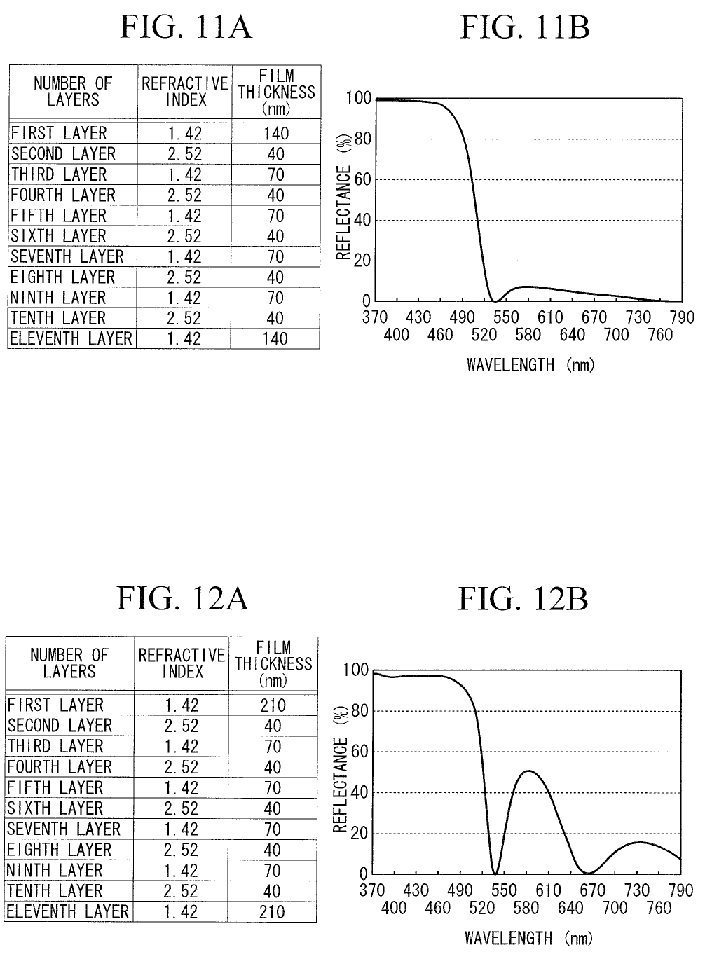

As shown in the light emitting characteristics of FIGS. 11B, 12B, and 13B, when the thicknesses of the uppermost layer and the lowermost layer are 2 times, 3 times, and 4 times the thickness of the layer that constitutes one of the intermediate layers and has the greatest thickness in the intermediate layers, it is possible to decrease the wavelength region of a reflective peak occurring in a region except for in a predetermined region.

Accordingly, in the third embodiment, in addition to the same effect as the first embodiment, it is possible to obtain more satisfactory color developing characteristics by the uppermost layer and the lowermost layer having thicknesses greater than that of the layer that constitutes one of the intermediate layers and has the greatest thickness in the intermediate layers.

Particularly, in the third embodiment, the thicknesses of the uppermost layer and the lowermost layer are formed 2 times (twice) the thickness of the layer that constitutes one of the intermediate layers and has the greatest thickness in the intermediate layers. Accordingly, it is possible to decrease the reflective peak in the wavelength region except for in a predetermined region, and it is possible to decrease the wavelength region of the reflective peak occurring in the region except for in a predetermined region, thereby obtaining more satisfactory color developing characteristics.

### Fourth Embodiment

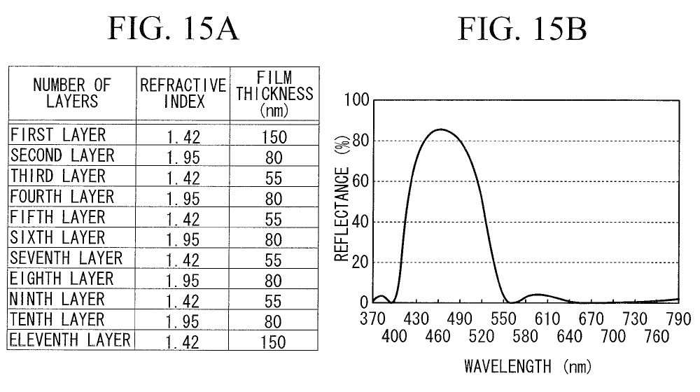

A fourth embodiment of a reference color developing section 11B and a method for manufacturing the same will be described with reference to FIGS. 15A and 15B.

In the first, the second, and the third embodiments, with respect to the first transparent thin film F1 and the second transparent thin film F2, the thickness of the first transparent thin film F1 having a small refractive index is greater than the thickness of the second transparent thin film F2 having a large refractive index. However, the fourth embodiment has a configuration opposite to the configuration of the first, the second, and the third embodiments.

FIG. 15A shows a diagram illustrating thicknesses of the first transparent thin film F1 formed by a siloxane polymer (refractive index 1.42) in the odd layers and the second transparent thin film F2 formed by a zinc oxide (refractive index 1.95) in the even layers as described above. FIG. 15B is a diagram illustrating light emitting characteristics, specifically illustrating the relationship between a light emitting wavelength and a reflectance in the reference color developing section 11B having the eleven layers shown in FIG. 15A.

As shown in FIG. 15A, in the fourth embodiment, except for the thicknesses of the uppermost layer and the lowermost layer, the thickness of the first transparent thin film F1 having a small refractive index is less than the thickness of the second transparent thin film F2 having a large refractive index.

Similarly with the third embodiment, the thicknesses of the uppermost layer and the lowermost layer are greater than the thickness of the layer that constitutes one of the intermediate layers and has the greatest thickness in the intermediate layers.

As shown in FIG. 15B, in the fourth embodiment, it is possible to decrease the reflective peak in the wavelength region except for a predetermined region, and it is possible to decrease the wavelength region of the reflective peak occurring in the region except for a predetermined region, thereby obtaining more satisfactory color developing characteristics.

In the above-described third and fourth embodiments, the thicknesses of the first transparent thin films F1 and the second transparent thin films F2 constituting the reference color developing section 11B are described. Similarly with the above-described third and fourth embodiments, with regard to the reference color developing sections 11R, 11G, the thicknesses of the uppermost layer and the lowermost layer are greater than the thickness of the layer that constitutes one of the intermediate layers and has the greatest thickness in the intermediate layers. Therefore, in the reference color developing sections 11R, 11G, it is possible to obtain the same effects as the third and fourth embodiments.

Electric Apparatus

Next, a specific example of the electronic apparatus including a display section constituted by the above liquid crystal display device is explained.

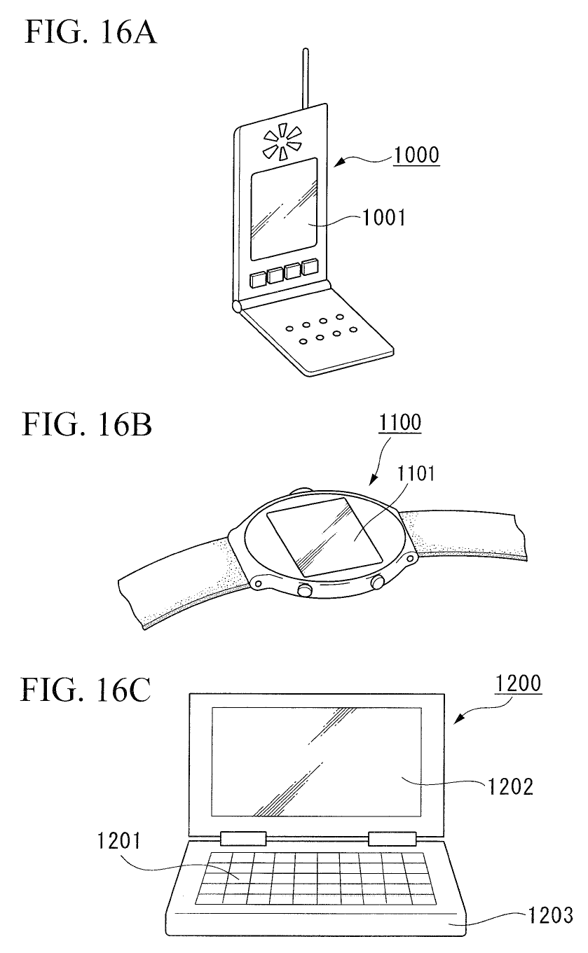

FIG. 16A is a perspective view of an example of a mobile phone.

In FIG. 16A, reference numeral 1000 indicates a mobile phone (electric apparatus). Reference numeral 1001 indicates a display section in which the above-described liquid crystal display device is used.

FIG. 16B is a perspective view of an example of a wristwatch-type electronic apparatus.

In FIG. 16B, reference numeral 1100 indicates a wristwatch (electric apparatus). Reference numeral 1101 indicates a display section in which the above-described liquid crystal display device is used.

FIG. 16C is a perspective view of an example of a portable information processing device such as a word processor and a personal computer.

In FIG. 16C, reference numeral 1200 indicates an information processing device (electric apparatus). Reference numeral 1201 indicates an input portion such as a keyboard. Reference numeral 1203 indicates a main unit of the information processing device (case). Reference numeral 1202 indicates a display section in which the above-described liquid crystal display device is used.

The electric apparatuses as shown in FIGS. 16A to 16C include the display section that is the above-described liquid crystal display device and formed by the above-described method for manufacturing the liquid crystal display device. It is thereby possible to obtain the electric apparatuses with a high quality in which a reduction in manufacturing cost and a reduction in the thickness of the electronic apparatus can be realized.

The technical scope of this invention shall not be limited to the above embodiments. As a matter of course, the invention may include various modifications of the embodiment in a scope not deviating from the spirit of this invention.

For example, in the above-described embodiments, the first transparent thin film F1 is formed in the odd layer and the second transparent thin film F2 is formed in the even layer, but the invention is not limited thereto and it may be opposite thereto.

The number of transparent thin films described in the embodiment is an example. If desired refractive characteristics can be obtained, the number may be greater than or less than eleven layers, that is, the number may be any number.

As the thickness of the transparent thin film in the embodiment, at least one of the first transparent thin film F1 and the second transparent thin film F2 may be formed to have a thickness as big as the particle diameter of the material for forming the first transparent thin film or the material for forming the second transparent thin film.

In this case, in order not to pile particles included in the applied liquid material upon the layer, it is preferable to employ a method in which the liquid material contains a dispersion catalyst.

When the transparent thin film having a thickness greater than the particle diameter is formed, it is possible to precisely form a film having a regular thickness and uniformity by making the thickness of the transparent thin film be integer times the particle diameter and by repeating the process for forming the film having the thickness as big as the particle diameter.

In the above-described embodiments, as a method for applying liquid materials for forming the first transparent thin film F1 and the second transparent thin film F2, a liquid droplet ejection method is used. The embodiment of the invention is not limited to the liquid droplet ejection method. Other application methods employing a liquid phase method, such as a spin coating or printing method, may be used.

While preferred embodiments of the invention have been described and illustrated above, these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A liquid crystal display device, comprising:
a first substrate;
a second substrate opposed to the first substrate;
a liquid crystal layer disposed between the first substrate and the second substrate; and
a color developing section that has a multilayered interference film in which first transparent thin films and second transparent thin films are alternatively stacked in layers, and causes light passed through the liquid crystal layer to have predetermined color developing characteristics and to be emitted from the color developing section, each of the first transparent thin films being formed with a first formation material and having a first refractive index so that each of the first transparent thin films has a thickness determined based on the predetermined color developing characteristics, and each of the second transparent thin films being formed with a second formation material and having a second refractive index so that each of the second transparent thin films has a thickness determined based on the predetermined color developing characteristics.

2. The liquid crystal display device according to claim 1, wherein
the color developing section has a plurality of reference color developing sections, one of the reference color developing sections produces one reference color different from the other reference color of the reference color developing sections, and each of the reference color developing sections has the first transparent thin film and the second transparent thin film which are stacked in layers so that the thicknesses of the first transparent thin film and the second transparent thin film correspond to the reference color of each of the reference color developing sections.

3. The liquid crystal display device according to claim 1, further comprising:
a division wall formed with a shading material, wherein
the color developing section is surrounded by the division wall.

4. The liquid crystal display device according to claim 1, wherein
the multilayered interference film includes a first face, a second face which is opposite to the first face, and an irregularity formation section that forms an irregularity on the first face of the multilayered interference film.

5. The liquid crystal display device according to claim 4, wherein
the irregularity formation section is a plurality of granular members dispersed and formed at a position which is close to the second face of the multilayered interference film.

6. The liquid crystal display device according to claim 5, wherein
the irregularity formation section is formed of at least one of the first formation material and the second formation material.

7. The liquid crystal display device according to claim 1, wherein
the first refractive index is less than the second refractive index, and the first transparent thin film is formed so that the thickness of the first transparent thin film is greater than the thickness of the second transparent thin film.

8. The liquid crystal display device according to claim 1, wherein
the multilayered interference film that has a plurality of the first transparent thin films and a plurality of the second transparent thin films includes a lowermost layer, an uppermost layer, and a plurality of intermediate layers, and wherein
the first transparent thin films and the second transparent thin films are formed so that the thicknesses of transparent thin films that are positioned at the lowermost layer and the uppermost layer are greater than the thickness of a transparent thin film that is positioned at one of the intermediate layers.

9. The liquid crystal display device according to claim 8, wherein
the first transparent thin films and the second transparent thin films are formed so that the thicknesses of the transparent thin films that are positioned at the lowermost layer and the uppermost layer are twice the thickness of the transparent thin film that is positioned at one of the intermediate layers.

10. The liquid crystal display device according to claim 1, wherein
the thickness of the first transparent thin film is determined based on a particle diameter of the first formation material.

11. The liquid crystal display device according to claim 1, wherein
the thickness of the second transparent thin film is determined based on a particle diameter of the second formation material.

12. An electronic apparatus comprising:
the liquid crystal display device according to claim 1.

13. A method for manufacturing a liquid crystal display device, comprising:
preparing a first substrate and a second substrate opposed to the first substrate;
disposing a liquid crystal layer between the first substrate and the second substrate;
forming a first transparent thin film having a first refractive index with a first liquid material so that the first transparent thin film has a thickness determined based on predetermined color developing characteristics;
forming a second transparent thin film having a second refractive index with a second liquid material so that the second transparent thin film has a thickness determined based on the predetermined color developing characteristics;
stacking the first transparent thin films and the second transparent thin films in layers by alternately repeating the forming of the first transparent thin film and the forming of the second transparent thin film multiple times so that a multilayered interference film is formed; and
obtaining a color developing section that causes light passed through the liquid crystal layer to have predetermined color developing characteristics and to be emitted from the color developing section.

14. The method according to claim 13, wherein
obtaining the color developing section includes forming a plurality of reference color developing sections, and one of the reference color developing sections produces one reference color different from the other reference color of the other of the reference color developing sections, and wherein
the first transparent thin films and the second transparent thin films are stacked in layers in the forming of the reference color developing sections so that the thicknesses of the first transparent thin film and the second transparent thin film correspond to the reference color of each of the reference color developing sections.

15. The method according to claim 13, further comprising:
forming a division wall with a shading material so that the color developing section is surrounded by the division wall.

16. The method according to claim 13, further comprising:
forming an irregularity formation section that forms an irregularity on a first face of the multilayered interference film.

17. The method according to claim 16, wherein
forming of the irregularity formation section includes forming a plurality of granular members at a position which is close to a second face which is opposite to the first face of the multilayered interference film, in a way that the granular members are dispersed.

18. The method according to claim 17, wherein the granular members is formed from at least one of the first liquid material and
the second liquid material.

19. The method according to claim 13, wherein
at least one of the first transparent thin film and the second transparent thin film is formed by a liquid droplet ejection method.

20. The method according to claim 13, wherein
each of the forming of the first transparent thin film and the forming of the second transparent thin film includes:
applying a liquid material; and
baking or drying the liquid material that has been applied.

21. The method according to claim 13, wherein
the first refractive index is less than the second refractive index, and the first transparent thin film is formed so that the thickness of the first transparent thin film is greater than the thickness of the second transparent thin film.

22. The method according to claim 13, wherein
the multilayered interference film that has a plurality of the first transparent thin films and a plurality of the second transparent thin films includes a lowermost layer, an uppermost layer, and a plurality of intermediate layers, and wherein
the first transparent thin films and the second transparent thin films are formed so that the thicknesses of transparent thin films that are positioned at the lowermost layer and the uppermost layer are greater than the thickness of a transparent thin film that is positioned at one of the intermediate layers.

23. The method according to claim 22, wherein
the first transparent thin films and the second transparent thin films are formed so that the thicknesses of the transparent thin films that are positioned at the lowermost layer and the uppermost layer are twice the thickness of the transparent thin film that is positioned at one of the intermediate layers.

24. The method according to claim 13, wherein
the forming of the first transparent thin film and the second transparent thin film includes at least one of the forming the first transparent thin film that has the thickness determined based on a particle diameter of a first formation material used for forming the first transparent thin film, and forming the second transparent thin film that has the thickness determined based on a particle diameter of a second formation material used for forming the second transparent thin film.
